(19) United States
(12) Patent Application Publication
(10) Pub. No.: US 2026/0147478 A1
(43) Pub. Date: May 28, 2026

(54) STORAGE OPTIMIZATION

(71) Applicant: CAST AI Group, Inc., Miami, FL (US)

(72) Inventor: Augustinas Stirbis, Miami, FL (US)

(21) Appl. No.: 19/399,131

(22) Filed: Nov. 24, 2025

Related U.S. Application Data
(60) Provisional application No. 63/723,745, filed on Nov. 22, 2024.

(51) Int. Cl. G06F 3/06

(52) U.S. Cl. CPC G06F 3/0608; G06F 3/0653; G06F 3/067

(57) ABSTRACT

A method, a non-transitory computer-readable medium, and a system for optimizing storage in a cloud computing environment that comprises receiving, by a processor, a persistent volume claim (PVC) for storage by a workload; automatically providing, by the processor, a storage class to the PVC for storage provisioning; dynamically creating, by the processor, a persistent volume (PV) based on the storage class; and automatically binding, by the processor, the PV to the PVC, wherein the PV is formatted with a B-tree file system (Btrfs).

### CROSS-REFERENCE TO RELATED APPLICATIONS

This application claims priority under 35 USC § 119(e) to U.S. Provisional Application No. 63/723,745, filed on Nov. 22, 2024, the contents of which are incorporated herein by reference in their entirety.

### BACKGROUND

### Field

The present disclosure relates to storage optimization in cloud computing environments, and more particularly to automated systems and methods for dynamically managing and provisioning cloud storage resources to reduce costs and improve efficiency.

### Related Art

Cloud computing environments have revolutionized the way organizations manage and scale their IT infrastructure. These environments provide on-demand access to a shared pool of configurable computing resources, including storage, that can be rapidly provisioned and released with minimal management effort. As businesses increasingly migrate their operations to the cloud, efficient management of storage resources has become a critical concern.

Storage in cloud environments typically involves provisioning disk capacity and performance characteristics such as input/output operations per second (IOPS) and throughput. Cloud service providers often charge based on the provisioned capacity and performance levels, regardless of actual utilization. This pricing model can lead to inefficiencies where organizations over-provision storage resources to accommodate potential future needs or peak usage scenarios.

Many organizations struggle to accurately predict their storage requirements, often resulting in significant over-provisioning. This practice, while ensuring sufficient capacity for anticipated growth, can lead to unnecessary costs. Conversely, under-provisioning can result in performance issues and potential service disruptions. Striking the right balance between cost-effectiveness and performance is an ongoing challenge for cloud storage management.

Traditional approaches to storage management in cloud environments often rely on manual intervention and periodic adjustments based on observed usage patterns. However, these methods can be time-consuming, error-prone, and may not respond quickly enough to changing workload demands. Additionally, the complexity of modern cloud infrastructures, with multiple storage types and performance tiers, further complicates the task of optimizing storage resources.

The dynamic nature of cloud workloads presents another challenge for storage optimization. Applications may experience sudden spikes in demand or seasonal variations, requiring rapid adjustments to storage allocations. Manual processes are often inadequate for responding to these fluctuations in real-time, potentially leading to periods of over-provisioning or performance bottlenecks.

While data compression and deduplication techniques can help reduce storage consumption, their effectiveness varies depending on the nature of the data and the specific workload characteristics. Implementing these techniques without impacting application performance requires careful consideration and ongoing monitoring.

As organizations continue to expand their use of cloud services, the need for more sophisticated approaches to storage optimization becomes increasingly apparent. Improved methods for automatically assessing storage requirements, dynamically adjusting provisioned resources, and optimizing data placement across different storage tiers could potentially yield substantial cost savings and performance improvements.

Addressing these challenges in cloud storage management requires innovative solutions that can automate decision-making processes, adapt to changing workload patterns, and optimize resource allocation in real-time. Such advancements could significantly enhance the efficiency and cost-effectiveness of cloud computing environments.

### SUMMARY

In an embodiment, a method for optimizing storage in a cloud computing environment comprises: receiving, by a processor, a persistent volume claim (PVC) for storage by a workload; automatically providing, by the processor, a storage class to the PVC for storage provisioning; dynamically creating, by the processor, a persistent volume (PV) based on the storage class; and automatically binding, by the processor, the PV to the PVC, wherein the PV is formatted with B-tree file system (Btrfs).

The processor may be further configured to monitor application storage volume utilization and performance metrics of the PV; and optimize the PV based on the application storage volume utilization and the performance metrics of the PV.

The optimizing the PV based on the application storage volume utilization and the performance metrics of the PV may comprise, for a storage need being detected based on the application storage volume utilization and the performance metrics of the PV, expanding size of the PV.

The optimizing the PV based on the application storage volume utilization and the performance metrics of the PV may comprise, for underutilization of storage being detected based on the application storage volume utilization and the performance metrics of the PV, trimming excess capacity from the PV without downtime.

The PV comprises a plurality of volumes, wherein the trimming excess capacity from the PV comprises: identifying a target volume from the plurality of volumes for removal; transferring data on the target volume to other volumes of the plurality of volumes; and deleting the target volume.

The optimizing the PV based on the application storage volume utilization and the performance metrics of the PV comprises modifying Input/Output Operations Per Second (IOPS) associated with the PV.

The processor may be further configured to compress data stored on the PV based on a predetermined compression level.

In an embodiment, a non-transitory computer readable medium storing instructions that, when executed by a processor, cause the processor to perform operations comprising: receiving a persistent volume claim (PVC) for storage by a workload; automatically providing a storage class to the PVC for storage provisioning; dynamically creating a persistent volume (PV) based on the storage class; and automatically binding the PV to the PVC, wherein the PV is formatted with B-tree file system (Btrfs).

The processor may be further configured to monitor application storage volume utilization and performance metrics of the PV; and optimize the PV based on the application storage volume utilization and the performance metrics of the PV.

The optimizing the PV based on the application storage volume utilization and the performance metrics of the PV may comprise, for a storage need being detected based on the application storage volume utilization and the performance metrics of the PV, expanding size of the PV.

The optimizing the PV based on the application storage volume utilization and the performance metrics of the PV may comprise, for underutilization of storage being detected based on the application storage volume utilization and the performance metrics of the PV, trimming excess capacity from the PV without downtime.

The PV comprises a plurality of volumes, wherein the trimming excess capacity from the PV comprises: identifying a target volume from the plurality of volumes for removal; transferring data on the target volume to other volumes of the plurality of volumes; and deleting the target volume.

The optimizing the PV based on the application storage volume utilization and the performance metrics of the PV comprises modifying Input/Output Operations Per Second (IOPS) associated with the PV.

The processor may be further configured to compress data stored on the PV based on a predetermined compression level.

In an embodiment, a storage optimization system for a cloud computing environment comprising: a data storage; and a processor in communication with the data storage, the processor is configured to: receive a persistent volume claim (PVC) for storage by a workload; automatically provide a storage class to the PVC for storage provisioning; dynamically create a persistent volume (PV) out of the data storage based on the storage class; and automatically bind the PV to the PVC, wherein the PV is formatted with B-tree file system (Btrfs).

The processor may be further configured to monitor application storage volume utilization and performance metrics of the PV; and optimize the PV based on the application storage volume utilization and the performance metrics of the PV.

The optimizing the PV based on the application storage volume utilization and the performance metrics of the PV may comprise, for a storage need being detected based on the application storage volume utilization and the performance metrics of the PV, expanding size of the PV.

The optimizing the PV based on the application storage volume utilization and the performance metrics of the PV may comprise, for underutilization of storage being detected based on the application storage volume utilization and the performance metrics of the PV, trimming excess capacity from the PV without downtime.

The PV comprises a plurality of volumes, wherein the trimming excess capacity from the PV comprises: identifying a target volume from the plurality of volumes for removal; transferring data on the target volume to other volumes of the plurality of volumes; and deleting the target volume.

The optimizing the PV based on the application storage volume utilization and the performance metrics of the PV comprises modifying Input/Output Operations Per Second (IOPS) associated with the PV.

The processor may be further configured to compress data stored on the PV based on a predetermined compression level.

### BRIEF DESCRIPTION OF DRAWINGS

A general architecture that implements the various features of the disclosure will now be described with reference to the drawings. The drawings and the associated descriptions are provided to illustrate example embodiments of the disclosure and not to limit the scope of the disclosure. Throughout the drawings, reference numbers are reused to indicate correspondence between referenced elements.

FIG. 1 illustrates an overview of the storage optimization system 100, in accordance with some example embodiments.

FIG. 2 illustrates an example volume output 200 derived using the storage optimization system 100 of FIG. 1, in accordance with some example embodiments.

FIG. 3 illustrates an overview of the storage optimization process 300, in accordance with some example embodiments.

FIG. 4 illustrates an example migration process 400 for migrating existing application data, in accordance with some example embodiments.

FIG. 5 illustrates an example computing environment with an example computer device suitable for use in some example embodiments.

FIG. 6 illustrates an example process 600 for performing storage optimization in a cloud computing environment, in accordance with some example embodiments.

### DETAILED DESCRIPTION

The following detailed description provides details of the figures and example embodiments of the present application. Reference numerals and descriptions of redundant elements between figures are omitted for clarity. Terms used throughout the description are provided as examples and are not intended to be limiting. For example, the use of the term “automatic” may involve fully automatic or semi-automatic embodiments involving user or administrator control over certain aspects of the embodiment, depending on the desired embodiment of one of the ordinary skills in the art practicing embodiments of the present application. Selection can be conducted by a user through a user interface or other input means, or can be implemented through a desired algorithm. Example embodiments as described herein can be utilized either singularly or in combination and the functionality of the example embodiments can be implemented through any means according to the desired embodiments.

The present disclosure relates to systems, methods, and computer-readable media for dynamically managing and provisioning cloud storage resources. The system provides automated management and optimization of storage resources in cloud computing environments (e.g., Kubernetes clusters), through use of a storage autoscaler. The storage autoscaler continuously monitors storage utilization and performance metrics within the Kubernetes cluster. Based on observed usage patterns, the storage autoscaler may automatically adjust storage provisioning to optimize resource allocation and reduce costs.

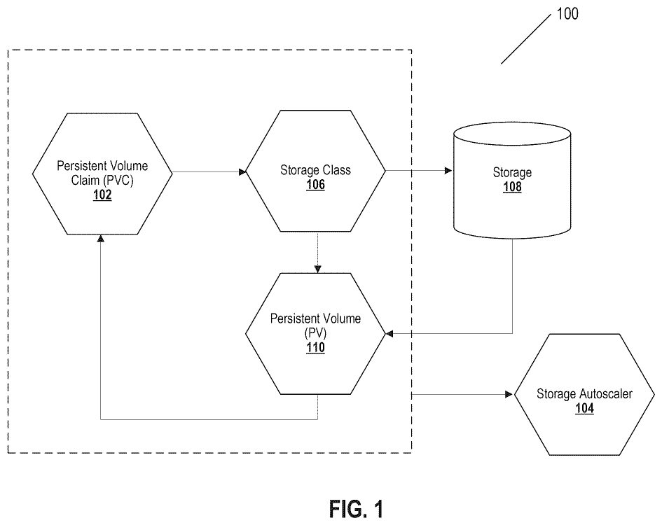

FIG. 1 illustrates an overview of the storage optimization system 100, in accordance with some example embodiments. Kubernetes pod may be depicted as workload, which contains persistent volume claim (PVC) 102. The PVC 102 is a request for storage and may contain a specific reference to a storage class 106, which provides a template/blueprint for creating persistent volumes (PVs) that match the requirements of PVC 102.

In some embodiments, a single/default storage class is available for selection where no specific request is made in the PVC 102. The single/default storage class serves as a comprehensive replacement for multiple traditional block storage classes within the Kubernetes cluster. This single storage class may be designed to automatically handle the diverse storage requirements that were previously managed by separate storage classes for different performance tiers, capacity ranges, and cost optimization levels. In some embodiments, the single storage class may incorporate intelligent provisioning logic that analyzes application requirements and automatically selects the most appropriate underlying storage configuration. In some embodiments, the storage class may evaluate factors such as requested capacity, expected input/output operations per second (IOPS), throughput requirements, and latency sensitivity to determine the optimal storage backend configuration for each persistent volume claim. The storage class may support dynamic storage type selection, allowing it to provision different underlying storage technologies based on workload characteristics.

In other embodiments, a number of storages classes with different profiles (e.g., storage tiers, performance levels, etc.) are defined and provided by administrators. Storage class may be selected based on factors such as read/write patterns, I/O operations per second (IOPS) requirements, and storage capacity utilization. Based on this analysis, the system may dynamically switch between different storage types (e.g., SSD or HDD) or adjust performance parameters to balance cost and performance.

The storage class 106 may utilize a copy-on-write file system, such as B-tree file system (Btrfs) for managing storage volumes. Copy-on-write file systems offer potential advantages over traditional journaling file systems (e.g., ext3, ext4) in terms of flexibility and efficiency. For instance, copy-on write systems copies only modified pages, which minimizes overhead when compared to journaling file systems that log every single change.

The storage class 106 may analyze application requirements and cluster-wide policies to determine the most appropriate storage configuration for each persistent volume. This analysis may consider factors such as required capacity, expected input/output operations per second (IOPS), and anticipated read/write patterns.

In some cases, the storage class 106 may leverage the capabilities of the underlying copy-on-write file system to implement advanced storage optimization techniques. These techniques may include transparent compression of data, efficient snapshotting, or dynamic resizing of storage volumes without disrupting application operations.

The storage class 106 may work in conjunction with other elements of the storage optimization system, such as the storage autoscaler 104, to continuously refine and adjust storage provisioning based on evolving application needs and cluster conditions. This dynamic approach to storage management may help maintain an optimal balance between performance, capacity, and cost-efficiency within the Kubernetes environment.

Under dynamic provisioning, one or more disks are created from storage resources, storage 108 and bound to persistent volume (PV) 110, which is the actual storage volume(s) accessible by applications running in a cluster. After the PV 110 is generated, it is then bound to the PVC 102 for use by the applications.

The storage autoscaler 104 monitors storage utilization and performance metrics within the cluster in real-time. Specifically, the storage autoscaler 104 analyzes data related to application storage volume usage following provisioning, including provisioned capacity, used space percentage, and read/write patterns. Additionally, the storage autoscaler 104 tracks performance metrics such as input/output operations per second (IOPS), bandwidth, disk queue length, etc.

Based on the monitored data, the storage autoscaler 104 may automatically take actions to optimize storage resources. In some cases, the storage autoscaler 104 may dynamically adjust the storage volume size by adding or removing disks from a storage pool. This capability allows the system to scale storage capacity up or down as needed, potentially reducing costs by eliminating unnecessary provisioned space.

In some embodiments, the storage autoscaler 104 may form storage volumes from multiple smaller disks rather than a single large disk. This approach provides flexibility in managing storage resources and may enable more granular optimization. For example, if an application initially requests a 500 GB volume, the storage autoscaler 104 may provision this capacity using a plurality of smaller disks (e.g., two 250 GB disks, five 100 GB disks, etc.).

In some embodiments, the storage autoscaler 104 may further compress data on write to effectively reduce the used space within persistent volumes. This compression may result in space savings ranging from 20% to 70% for various file types (e.g., JSON, binary, etc.) or applications (e.g., Kafka™, Prometheus™, Cassandra™, ElasticSearch™, persistent Redis™, etc.).

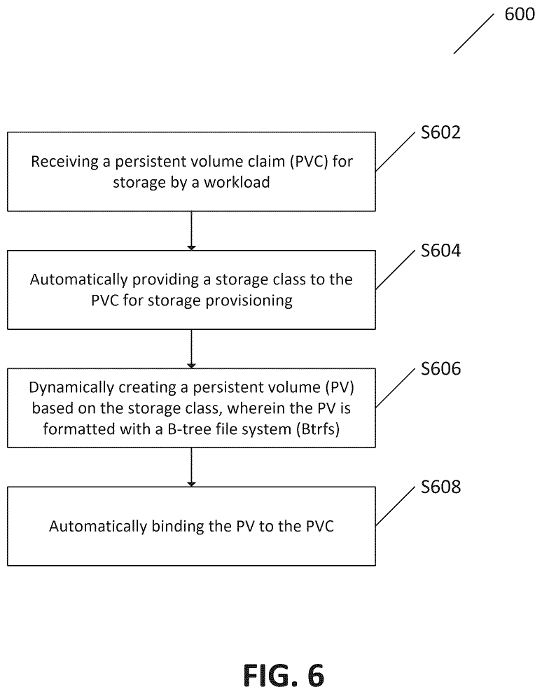

The storage autoscaler 104 may also analyze storage performance requirements and automatically select the most appropriate and cost-effective storage type. For instance, the system may transition between different storage types (e.g., from io2 to gp3) based on observed performance needs and user-defined policies. The storage optimization system 100 may further analyze historical storage usage data to predict future storage needs. The storage optimization system 100 may then proactively adjust storage provisioning to meet anticipated demand while minimizing overprovisioning. By automating storage optimization decisions, the system may reduce manual configuration overhead for cluster administrators while improving overall storage efficiency and cost-effectiveness in cloud environments. FIG. 6 illustrates an example process 600 for performing storage optimization in a cloud computing environment, in accordance with some example embodiments. The process 600 may begin by receiving a persistent volume claim (PVC) for storage by a workload at block S602. The process then continues to block S604 where a storage class is automatically provided to the PVC for storage provisioning. At block S606, a persistent volume (PV) is dynamically created based on the storage class. In some embodiments, the PV is formatted with a B-tree file system (Btrfs). Specifically, volumes are first attached to Kubernetes node and formed to Btrfs, which are then mounted to /var/lib/kubelet/pods, and then mounted to kubelet/pods. At block S608, the PV is automatically bound to the PVC.

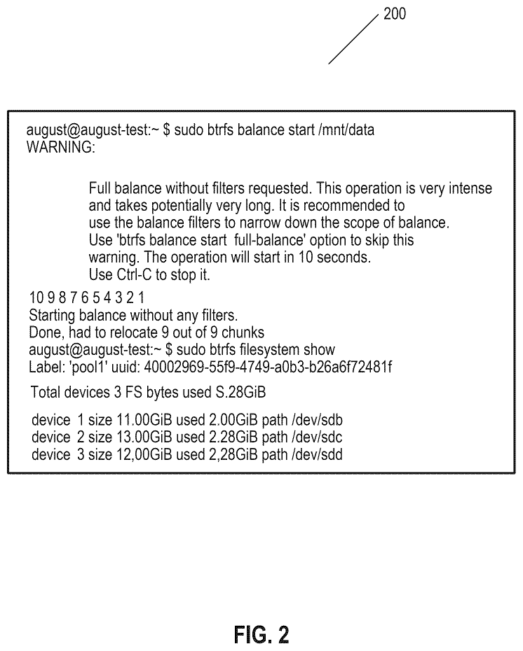

FIG. 2 illustrates an example volume output 200 derived using the storage optimization system 100 of FIG. 1, in accordance with some example embodiments. As illustrated in FIG. 2, a total volume/capacity of 36 GB has been provisioned and represents the overall available storage. The total volume is shared between three storage devices: device 1, device 2, and device 3. Device 1 has a size of 11.00 GB, with 2 GB of used space. Device 2 has a size of 13.00 GB, with 2.28 GB of used space. Device 3 has a size of 12.00 GB, with 2.28 GB of used space. The three storage devices, together, operate as part of a B-tree file system (Btrfs) filesystem, which allows for data management operations such as balancing, compression, and storage pool management.

In some cases, the utilized space within the storage pool may be compressed to reduce the actual storage volume required. The Btrfs filesystem allows for compression to be applied at the filesystem level. The compression level of the storage volume may be adjusted to optimize for performance or space savings based on the specific requirements of the applications using the storage.

The storage pool may support dynamic provisioning operations by adding or removing storage devices without disrupting ongoing operations. For example, storage devices may be removed/deleted/trimmed from the pool when storage requirements decrease, or additional storage devices may be added when capacity expansion is needed. The Btrfs filesystem may facilitate these operations by redistributing data across the remaining devices in the pool.

The system may monitor and display storage utilization metrics for the combined storage pool formed by the three devices. For example, utilization metrics may be used to optimize the total volume/capacity by adding or removing storage devices. When device 1 is determined to be underutilized (e.g., dropping below a predetermined threshold), the system may reduce the provisioned space from 36 GB to 25 GB by moving/distributing data stored in device 1 to device 2 and device 3, and removing device 1 from the pool.

In the alternative, a disk with a smaller volume may be created (e.g., 10 GB) to replace device 1. The system may also determine that since the total used space between the three devices amount to less than 10 GB, a new disk with a smaller volume may be created (e.g., 8 GB) and used to replace all three devices.

Data may be distributed across device 1, device 2, and device 3 in a balanced manner, which provides performance benefits by distributing input/output operations across multiple physical devices. This distribution may help reduce bottlenecks and improve overall storage system throughput. In some cases, the storage system may perform balancing operations to ensure that data is evenly distributed across all devices in the pool. These balancing operations may relocate data chunks between devices to maintain optimal distribution and performance characteristics across the storage pool.

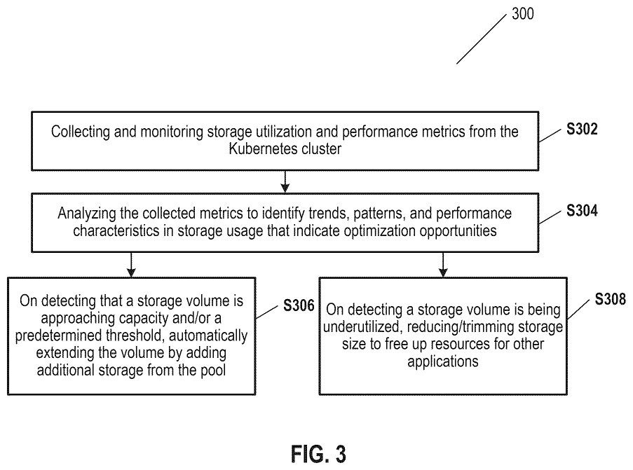

FIG. 3 illustrates an overview of the storage optimization process 300, in accordance with some example embodiments. The process begins by may begin by collecting and monitoring storage utilization and performance metrics from the Kubernetes cluster using the storage optimization system 100 at block S302. The storage autoscaler 104 may be used to monitor data on storage capacity usage, read/write patterns, and performance indicators such as input/output operations per second (IOPS) and latency, bandwidth utilization, and disk queue lengths across all persistent volumes in the cluster.

At block S304, the collected metrics are analyzed to identify trends, patterns, and performance characteristics in storage usage that indicate optimization opportunities. This analysis may involve comparing current usage against historical data and predicting future storage needs based on observed growth rates or cyclical patterns. In some cases, the analysis may reveal that certain storage volumes are approaching capacity limits while others remain significantly underutilized. The system may also detect performance bottlenecks where applications experience high latency or reduced throughput due to storage configuration limitations.

Based on the analysis, the storage optimization system 100 initiates automated decision-making processes to determine appropriate optimization actions in real-time. The system may evaluate multiple factors when making these decisions, including current utilization rates, historical growth patterns, application performance requirements, and cost considerations.

If the system detects that a storage volume is approaching capacity and/or a predetermined threshold (e.g., a preset value, percentage, etc.), the system may automatically extend the volume by adding additional storage from the pool at block S306. The system may add additional storage capacity by incorporating new disks into the existing storage pool or by expanding existing volumes through cloud provider APIs. Conversely, if a volume is being underutilized (e.g., below a preset value, percentage, etc.), the system may reduce/trim storage size to free up resources for other applications at block S308. For example, one or more volumes of a plurality of volumes may be identified, detached, and removed/trimmed to free up resources. In the alternative, a 100 GB disk may be created and attached to an existing 500 GB volume, so that the existing volume may be deleted after data transfer is performed.

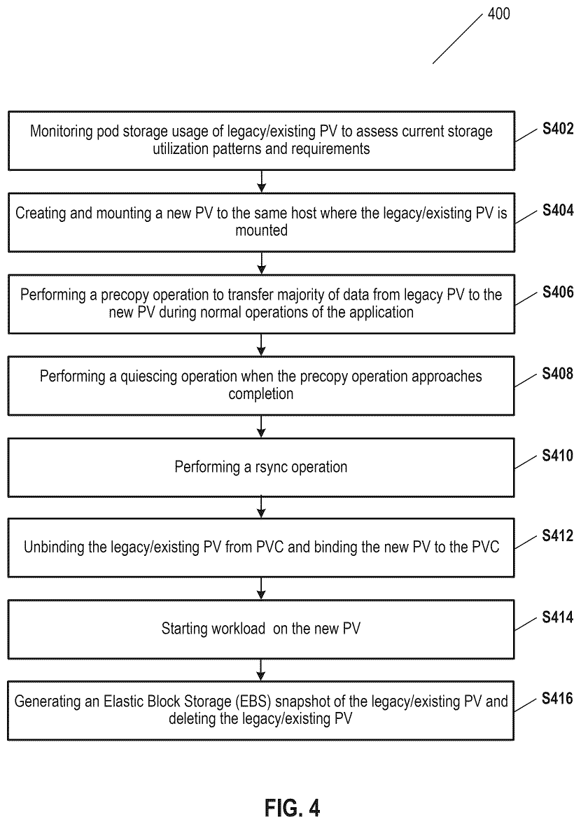

In some embodiments, the storage optimization system 100 may also consider performance requirements when making allocation decisions. If an application exhibits high IOPS or low latency requirements, the system may migrate the associated storage to a higher-performance tier or adjust the underlying storage configuration to meet these needs. For instance, when applications exhibit high IOPS requirements or low latency needs that are not being met by the current storage configuration, the system may migrate data to higher-performance storage tiers. Conversely, when applications have lower performance requirements, the system may migrate data to more cost-effective storage options. This is described in more detail below in relation to FIG. 4.

In some embodiments, appropriate optimization actions are derived using an Artificial Intelligence (AI)/Machine Learning (ML) model that has been trained using historical utilization and performance metrics, characteristics, and actions performed. The AI/ML model may include, but not limited to, convolutional neural network (CNN), recurrent neural network (RNN), deep RNN (DRNN), Q-learning network (QN), deep Q-learning network (DQN), linear regression, decision trees, K-Nearest Neighbors, etc. RNN may include long short-term memory (LSTM), etc.

In some cases, the storage optimization system 100 may also employ data compression techniques to optimize storage utilization. The system may analyze file types, data patterns, and compression ratios to determine when compression would provide substantial space savings without adversely affecting application performance. In some cases, the system may apply different compression levels based on the performance sensitivity of the applications using the storage.

The system may consider usage patterns when making optimization decisions. Applications with predictable access patterns, such as batch processing workloads, may be candidates for different optimization strategies compared to applications with random access patterns. The system may also analyze temporal usage patterns to identify opportunities for storage optimization during periods of lower activity. For example, modifying IOPS associated with the PV.

Performance requirements may be evaluated continuously to ensure that optimization actions do not negatively impact application functionality. The system may maintain performance baselines and monitor key metrics such as response times, throughput, and error rates to validate that optimization actions achieve the intended benefits without degrading service quality.

Data may be balanced across multiple disks in the storage pool to optimize performance characteristics. The balancing process may distribute data chunks evenly across available storage devices to maximize parallel access capabilities and reduce potential bottlenecks. In some cases, the system may relocate data between disks based on access patterns, moving frequently accessed data to higher-performance devices while relocating less active data to standard storage devices.

The automated optimization process may operate continuously, allowing the system to adapt to changing storage requirements and usage patterns over time. The system may implement feedback mechanisms to evaluate the effectiveness of optimization actions and refine decision-making algorithms based on observed outcomes.

The storage optimization system 100 may also include functionality for migrating existing application data from native storage solutions to the optimized storage architecture. This migration process may be designed to minimize disruption to running applications while transitioning workloads to a more efficient storage configuration.

FIG. 4 illustrates an example migration process 400 for migrating existing application data, in accordance with some example embodiments. The migration process 400 may begin by monitoring pod storage usage of legacy/existing PV to assess current storage utilization patterns and requirements at block S402. Monitoring is performed by storage autoscaler 104 and provides data about storage capacity usage, performance characteristics, and application behavior that informs the migration strategy.

At block S404, a new PV is created and mounted to the same host where the legacy/existing PV is mounted. This involves taking actions (e.g., making API calls to cloud providers) to orchestrate various migrations steps in ensuring proper sequencing and error handling. The new PV may be provisioned using an optimized storage class and may be configured based on the observed usage patterns and performance requirements of the legacy/existing PV. In some embodiments, only a single/default storage class may be provided in generating the new PV.

At block S406, a precopy operation is performed to transfer majority of data from legacy PV to the new PV during normal operations of the application. This precopy operation may run in the background and may handle large data transfers without impacting application performance. When the precopy operation approaches completion, a quiescing operation is performed at block S408. During the quiescing operation, ongoing activities on the legacy PV are paused and new writes are stopped to ensure that data is not in a volatile state.

To minimize downtime during the migration, a rsync process is then performed at block S410 to checksum validate information consistency between the legacy/existing PV against the new PV, and copy over any residual deltas. This ensures that all data has been accurately transferred to the new PV. After data transfer completion and validation, the system may unbind the legacy/existing PV from PVC and bind the new PV to the PVC at block S412. This operation may update the Kubernetes cluster configuration to redirect PVC from the legacy/existing PV to the new PV.

Once the binding operation has been completed, the workload may start on the same node or on a different node within the cluster on the new PV at block S414. The workload may resume normal operations using the new PV with minimal disruption to application functionality. The migration process allows for application state and data accessibility to be maintained throughout the transition.

The process then continues to block S416 where an Elastic Block Storage (EBS) snapshot of the legacy/existing PV is generated and the legacy/existing PV is deleted. The EBS snapshot creates a snapshot of the original storage volume, the legacy/existing PV, before it is removed from the system. This recovery mechanism allows for storage resources that are no longer needed to be freed up after the successful migration to the optimized storage solution.

The migration process may operate with minimal downtime by leveraging the precopy and incremental synchronization approach. The bulk of data transfer may occur while applications remain operational, with only a brief interruption during the final synchronization and binding operations. This approach may enable large-scale storage migrations without significant impact on application availability or user experience.

The storage optimization system 100 may also provide monitoring and reporting capabilities throughout the migration process. These features may allow administrators to track the progress of data transfers, identify any potential issues, and gain insights into the performance improvements achieved through the migration to optimized storage.

The foregoing example embodiments may have various benefits and advantages. For example, the systems, methods, and computer-readable media described herein provide improved management and provision of cloud storage resources. The storage optimization system provides automated management and optimization of storage resources in cloud computing environments (e.g., Kubernetes clusters), through use of a storage autoscaler. The storage autoscaler continuously monitors storage utilization and performance metrics within the Kubernetes cluster. Based on observed usage patterns, the storage autoscaler may automatically adjust storage provisioning to optimize resource allocation and reduce costs. A copy-on-write file system, such as Btrfs is utilized for storage volume management. Copy-on-write file systems offer advantages over traditional journaling file systems (e.g., ext3, ext4) in terms of flexibility and efficiency for certain storage optimization operations.

The storage optimization system may analyze historical storage usage data to predict future storage needs. The storage optimization system may then proactively adjust storage provisioning to meet anticipated demand while minimizing overprovisioning. By automating storage optimization decisions, the system may reduce manual configuration overhead for cluster administrators while improving overall storage efficiency (e.g., reducing time and resources needed to manage storage resources) and cost-effectiveness in cloud environments.

The storage optimization system may also include functionality for migrating existing application data from native storage solutions to the optimized storage architecture. This migration process may be designed to minimize disruption to running applications while transitioning workloads to a more efficient storage configuration.

In addition, the migration process operates with minimal downtime by leveraging the precopy and incremental synchronization approach. The bulk of data transfer may occur while applications remain operational, with only a brief interruption during the final synchronization and binding operations. This approach may enable large-scale storage migrations without significant impact on application availability or user experience.

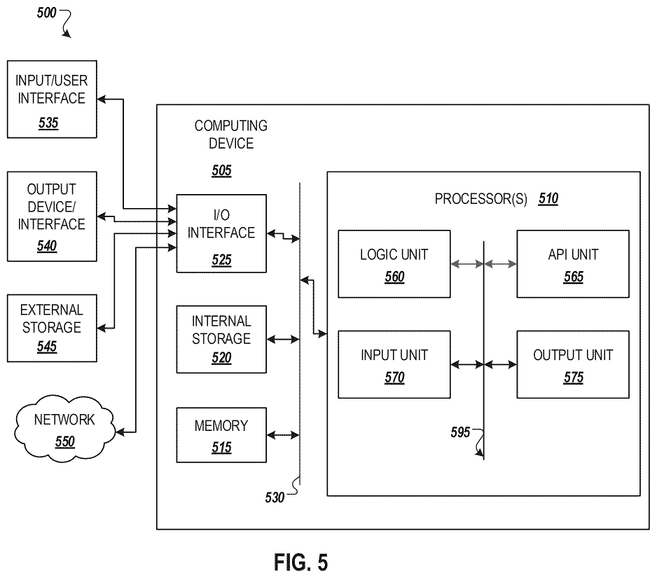

FIG. 5 illustrates an example computing environment with an example computer device suitable for use in some example embodiments. Computer device 505 in computing environment 500 can include one or more processing units, cores, or processors 510, memory 515 (e.g., RAM, ROM, and/or the like), internal storage 520 (e.g., magnetic, optical, solid-state storage, and/or organic), and/or IO interface 525, any of which can be coupled on a communication mechanism or bus 530 for communicating information or embedded in the Computer device 505. IO interface 525 is also configured to receive images from cameras or provide images to projectors or displays, depending on the desired embodiment.

Computer device 505 can be communicatively coupled to input/user interface 535 and output device/interface 540. Either one or both of the input/user interface 535 and output device/interface 540 can be a wired or wireless interface and can be detachable. Input/user interface 535 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 540 may include a display, television, monitor, printer, speaker, braille, or the like. In some example embodiments, input/user interface 535 and output device/interface 540 can be embedded with or physically coupled to the computer device 505. In other example embodiments, other computer devices may function as or provide the functions of input/user interface 535 and output device/interface 540 for a computer device 505.

Examples of computer device 505 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 505 can be communicatively coupled (e.g., via IO interface 525) to external storage 545 and network 550 for communicating with any number of networked components, devices, and systems, including one or more computer devices of the same or different configuration. Computer device 505 or any connected computer device can be functioning as, providing services of, or referred to as a server, client, thin server, general machine, special-purpose machine, or another label.

IO interface 525 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 500. Network 550 can be any network or combination of networks (e.g., the Internet, local area network, wide area network, a telephonic network, a cellular network, satellite network, and the like).

Computer device 505 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 505 can be used to implement techniques, methods, applications, processes, or computer-executable instructions in some example computing environments. Computer-executable instructions can be retrieved from transitory media and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 510 can execute under any operating system (OS) (not shown), in a native or virtual environment. One or more applications can be deployed that include logic unit 560, application programming interface (API) unit 565, input unit 570, output unit 575, and inter-unit communication mechanism 595 for the different units to communicate with each other, with the OS, and with other applications (not shown). The described units and elements can be varied in design, function, configuration, or embodiment and are not limited to the descriptions provided. Processor(s) 510 can be in the form of hardware processors such as central processing units (CPUs) or in a combination of hardware and software units.

In some example embodiments, when information or an execution instruction is received by API unit 565, it may be communicated to one or more other units (e.g., logic unit 560, input unit 570, output unit 575). In some instances, logic unit 560 may be configured to control the information flow among the units and direct the services provided by API unit 565, the input unit 570, the output unit 575, in some example embodiments described above. For example, the flow of one or more processes or embodiments may be controlled by logic unit 560 alone or in conjunction with API unit 565. The input unit 570 may be configured to obtain input for the calculations described in the example embodiments, and the output unit 575 may be configured to provide an output based on the calculations described in example embodiments.

Processor(s) 510 can be configured to receive a persistent volume claim (PVC) for storage by a workload as illustrated in FIG. 1 and FIG. 2. The processor(s) 510 may also be configured to automatically provide a storage class to the PVC for storage provisioning as illustrated in FIG. 1 and FIG. 2. The processor(s) 510 may also be configured to dynamically create a persistent volume (PV) based on the storage class as illustrated in FIG. 1 and FIG. 2. The processor(s) 510 may also be configured to automatically bind the PV to the PVC as illustrated in FIG. 1 and FIG. 2.

The processor(s) 510 may also be configured to monitor application storage volume utilization and performance metrics of the PV as illustrated in FIGS. 1-3. The processor(s) 510 may also be configured to optimize the PV based on the application storage volume utilization and the performance metrics of the PV as illustrated in FIGS. 1-3.

The processor(s) 510 may also be configured to, for a storage need being detected based on the application storage volume utilization and the performance metrics of the PV, expand size of the PV as illustrated in FIGS. 1-3. The processor(s) 510 may also be configured to, for underutilization of storage being detected based on the application storage volume utilization and the performance metrics of the PV, trim excess capacity from the PV without downtime as illustrated in FIGS. 1-3.

The processor(s) 510 may also be configured to identify a target volume from the plurality of volumes for removal as illustrated in FIGS. 1-3. The processor(s) 510 may also be configured to transfer data on the target volume to other volumes of the plurality of volumes as illustrated in FIGS. 1-3. The processor(s) 510 may also be configured to delete the target volume as illustrated in FIGS. 1-3.

The processor(s) 510 may also be configured to modify Input/Output Operations Per Second (IOPS) associated with the PV as illustrated in FIGS. 1-3. The processor(s) 510 may also be configured to compress data stored on the PV based on a predetermined compression level as illustrated in FIGS. 1-2.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example embodiments, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example embodiments may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software embodiments that involve instructions that perform the operations of the desired embodiment.

Various general-purpose systems may be used with programs and modules in accordance with the examples herein, or it may prove convenient to construct a more specialized apparatus to perform desired method steps. In addition, the example embodiments are not described with reference to any particular programming language. It will be appreciated that a variety of programming languages may be used to implement the teachings of the example embodiments as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example embodiments may be implemented using circuits and logic devices (hardware), while other aspects may be implemented using instructions stored on a machine-readable medium (software), which if executed by a processor, would cause the processor to perform a method to carry out embodiments of the present application. Further, some example embodiments of the present application may be performed solely in hardware, whereas other example embodiments may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other embodiments of the present application will be apparent to those skilled in the art from consideration of the specification and practice of the teachings of the present application. Various aspects and/or components of the described example embodiments may be used singly or in any combination. It is intended that the specification and example embodiments be considered as examples only, with the true scope and spirit of the present application being indicated by the following claims.

What is claimed is:

1. A method for optimizing storage in a cloud computing environment, comprising:
receiving, by a processor, a persistent volume claim (PVC) for storage by a workload;
automatically providing, by the processor, a storage class to the PVC for storage provisioning;
dynamically creating, by the processor, a persistent volume (PV) based on the storage class; and
automatically binding, by the processor, the PV to the PVC,
wherein the PV is formatted with a B-tree file system (Btrfs).

2. The method of claim 1, further comprising:
monitoring, by the processor, application storage volume utilization and performance metrics of the PV; and
optimizing, by the processor, the PV based on the application storage volume utilization and the performance metrics of the PV.

3. The method of claim 2, wherein the optimizing the PV based on the application storage volume utilization and the performance metrics of the PV comprises:
detecting a storage need based on the application storage volume utilization and the performance metrics of the PV, expanding a size of the PV.

4. The method of claim 3, wherein the optimizing the PV based on the application storage volume utilization and the performance metrics of the PV further comprises:
detecting underutilization of storage based on the application storage volume utilization and the performance metrics of the PV, trimming excess capacity from the PV.

5. The method of claim 4,
wherein the PV comprises a plurality of volumes,
wherein the trimming excess capacity from the PV comprises:
identifying a target volume from the plurality of volumes for removal;
transferring data on the target volume to other volumes of the plurality of volumes; and
deleting the target volume.

6. The method of claim 2, wherein the optimizing the PV based on the application storage volume utilization and the performance metrics of the PV comprises:
modifying Input/Output Operations Per Second (IOPS) associated with the PV.

7. The method of claim 1, further comprising:
compressing, by the processor, data stored on the PV based on a predetermined compression level.

8. A non-transitory computer-readable medium storing instructions that, when executed by a processor, cause the processor to perform operations comprising:
receiving a persistent volume claim (PVC) for storage by a workload;
automatically providing a storage class to the PVC for storage provisioning;
dynamically creating a persistent volume (PV) based on the storage class; and
automatically binding the PV to the PVC,
wherein the PV is formatted with a B-tree file system (Btrfs).

9. The non-transitory computer-readable medium of claim 8, wherein the processor is further configured to perform:
monitoring application storage volume utilization and performance metrics of the PV; and
optimizing the PV based on the application storage volume utilization and the performance metrics of the PV.

10. The non-transitory computer-readable medium of claim 9, wherein the optimizing the PV based on the application storage volume utilization and the performance metrics of the PV comprises:
detecting a storage need based on the application storage volume utilization and the performance metrics of the PV, expanding a size of the PV.

11. The non-transitory computer-readable medium of claim 10, wherein the optimizing the PV based on the application storage volume utilization and the performance metrics of the PV further comprises:
detecting underutilization of storage based on the application storage volume utilization and the performance metrics of the PV, trimming excess capacity from the PV.

12. The non-transitory computer-readable medium of claim 11,
wherein the PV comprises a plurality of volumes,
wherein the trimming excess capacity from the PV comprises:
identifying a target volume from the plurality of volumes for removal;
transferring data on the target volume to other volumes of the plurality of volumes; and
deleting the target volume.

13. The non-transitory computer-readable medium of claim 9, wherein the optimizing the PV based on the application storage volume utilization and the performance metrics of the PV comprises:
modifying Input/Output Operations Per Second (IOPS) associated with the PV.

14. The non-transitory computer-readable medium of claim 8, further comprising:
compressing, by the processor, data stored on the PV based on a predetermined compression level.

15. A storage optimization system for a cloud computing environment, comprising:
a data storage; and
a processor in communication with the data storage, the processor is configured to:
receive a persistent volume claim (PVC) for storage by a workload;
automatically provide a storage class to the PVC for storage provisioning;
dynamically create a persistent volume (PV) out of the data storage based on the storage class; and
automatically bind the PV to the PVC,
wherein the PV is formatted with a B-tree file system (Btrfs).

16. The storage optimization system of claim 15, wherein the processor is further configured to:
monitor application storage volume utilization and performance metrics of the PV; and
optimize the PV based on the application storage volume utilization and the performance metrics of the PV.

17. The storage optimization system of claim 16, wherein the optimize the PV based on the application storage volume utilization and the performance metrics of the PV comprises:
detecting a storage need based on the application storage volume utilization and the performance metrics of the PV, expand a size of the PV.

18. The storage optimization system of claim 17, wherein the optimize the PV based on the application storage volume utilization and the performance metrics of the PV further comprises:
detecting underutilization of storage based on the application storage volume utilization and the performance metrics of the PV, trim excess capacity from the PV.

19. The storage optimization system of claim 18,
wherein the PV comprises a plurality of volumes,
wherein the trim excess capacity from the PV comprises:
identifying a target volume from the plurality of volumes for removal;
transferring data on the target volume to other volumes of the plurality of volumes; and
deleting the target volume.

20. The storage optimization system of claim 16, wherein the optimize the PV based on the application storage volume utilization and the performance metrics of the PV comprises:
modifying Input/Output Operations Per Second (IOPS) associated with the PV.
